(19) United States
(12) Patent Application Publication
(10) Pub. No.: US 2022/0276373 A1
(43) Pub. Date: Sep. 1, 2022

(54) BANDWIDTH SELECTION FOR LOCATION DETERMINATION

(71) Applicant: IPCom GmbH & Co. KG, Pullach (DE)

(72) Inventors: Maik BIENAS, Schoeppenstedt (DE); Martin HANS, Bad Salzdetfurth (DE)

(73) Assignee: IPCom GmbH & Co. KG, Pullach (DE)

(21) Appl. No.: 17/597,780

(22) PCT Filed: Aug. 6, 2020
(86) PCT No.: PCT/EP2020/072153

§ 371 Date: Jan. 23, 2022

(30) Foreign Application Priority Data
Aug. 6, 2019 (EP) 19190177.6

(51) Int. Cl. G01S 13/87; G01S 13/76; G01S 5/02; H04L 5/00; H04W 64/00; H04W 4/02

(52) U.S. Cl. CPC G01S 13/878; G01S 13/765; G01S 13/767; G01S 5/0226; H04L 5/0053; H04L 5/0094; H04W 64/006; H04W 4/023

(57) ABSTRACT

The invention provides a method of assigning radio resources for transmitting and receiving measurement radio signals for determining a position of a cellular device (UE1), wherein at least one of a bandwidth, a pulse form, and a duration of the measurement radio signals is selected according to a positioning accuracy requirement of a requesting device.

The present invention relates to a technique for selecting a radio bandwidth for performing location determination.

A broad variety of methods is known to measure or estimate the distance between a mobile device and a fixed station. Radar systems for example measure the run-time of radio signals transmitted by a station and echoed by the station's environment. Time-of-flight cameras work in a similar manor typically transmitting and measuring infrared signals.

Satellite based positioning systems, such as GPS, Galileo or the like, estimate the distance between a mobile station and satellite stations by measuring the receive time of signals transmitted by a respective satellite and determining the transmit time from data provided by the satellite. The difference between transmit and receive time, also called time-of-flight, is used to calculate the distance.

Advanced methods like “differential GPS” (DGPS), “carrier phase GPS” (CPGPS) or “real-time kinematic” (RTK) use the phase of a carrier signal to increase the position accuracy to about 10 cm. Methods may use several surrounding ground-based reference stations with known positions which calculate and transmit position correction data via a mobile communication system to the mobile device. These methods have in common with the plain satellite-based positioning methods, that they require a line-of-sight between the device which position is to be determined and five or more satellites or reference stations. This makes the methods less appropriate for indoor positioning.

In mobile communication systems, positioning methods may be incorporated. Measurements of signal strength on signals, whose transmit power is known, allow a rough estimation of distance while multiple receive antennas like MIMO antennas or antenna arrays may measure the angle of arrival of received signals.

Observed time difference of arrival (OTDOA) methods are often incorporated into cellular mobile communication systems. For OTDOA the mobile device measures the receive time of reference signals transmitted by multiple base stations. The receive time is dependent on the time of transmission and the time of flight or speed of light and the distance between mobile device and the respective station. With the knowledge of the relative transmit time of the base station, the relative distance can be calculated, and by triangulation, the position of the mobile device can be estimated.

The OTDOA method as incorporated in known cellular communication systems like UMTS or LTE, uses time measurements on received reference signals. These reference signals can be signals sent by the base station for other purposes, e.g. for cell search or demodulation, or it can be signals that are dedicated for the purpose of position estimation. In both cases the reference signals confirm with the time-frequency-grid of the respective cellular system, i.e. they are using the system's slot configuration and the related symbol length in the time domain and the system's carrier spacing in the frequency domain.

The OTDOA method can also be performed with measurements on the uplink signals transmitted by the mobile device to multiple base station which determine the relative time difference of the received signals. The uplink signals are then similar reference signals confirming with the time-frequency-grid of the system's uplink resources.

In aviation and other vehicles, distance measurement equipment is known that estimates distances from transmitted signals that are actively responded to by a receiver device to which the distance is to be measured. The time at which the response is received depends on the distance, the speed of light and processing time in the responder, shown, for example in. EP 0 740 801.

In general, for a positioning method based on a time measurement of a received signal, the symbol duration of the symbols used for the signal influences the possible accuracy of the measurement. The shorter the symbol duration is, the more precisely the time instance of reception can be measured. According to the well-known physical dependencies, a shorter symbol has a larger bandwidth compared to a longer symbol with the same signal shape.

Increasing the accuracy of positioning methods incorporated into a cellular system will thus require signals to be transmitted which have a higher bandwidth and a shorter duration than compliant with the system's time-frequency-grid.

DE 102015013453 B3, also published as US 2018/0306913 A1, describes a relatively new method of measuring the distance between a mobile device and a fixed station in a similar way as described above. A first device (the device that transmits the first signal is called interrogator in the following text) transmits a signal that is very short in time. The signal is received by a second device (called transponder in the following text) and a response signal is transmitted. The distance determination in the first device takes into account the time difference between transmitting the interrogator signal and receiving the responds signal and the processing time in the transponder. In order to determine the processing time, the transponder transmits the response signal at one of distinct precisely defined time instances. With only few iterations of transmitting an interrogator signal and receiving the response, the first station can adapt the transmit timing so that from the time of receiving the response signal, an exact processing time can be derived and thus a very accurate time-of-flight calculation is possible. Based on the procedure described in that patent, the distance between the first and the second device can be estimated with a precision of as little as one centimetre.

In order to achieve this accuracy, the signals transmitted have to be very short and reliably detectable by the receiver, i.e. by demodulation in the respective receiver device with a suitable demodulation scheme. The modulation and short time constraints result in a large bandwidth of the signals.

To achieve an accuracy of the distance measurement of only a few centimetres for example, the signals need to be as short as 50 ns and the resulting bandwidth using a chirp signal shape is 100 MHz.

The positioning method of DE 102015013453 B3 can be deployed using a dedicated frequency spectrum, but as spectrum is a scarce and expensive resource and the signal is very short in time, an incorporation of the positioning estimation method in a cellular mobile communication system would be beneficial but has yet not been developed.

US 2009/0323596 A1 describes a method for scheduling of positioning channels and traffic. A scheduling manager controls the functionality including indicating time slots, frequency bands and bandwidth based on information received from base stations as to available resources, balancing a demand for positioning resources against other traffic and available hardware resources.

US 2018/0020423 A1 describes the use of narrow band positioning reference signals for locating devices. After a first position estimate, positioning measurements continue if a desired positioning accuracy has not been met.

US 2016/0095092 A1 describes resource allocation for location determination. Three types of location beacon are described. US 2018/0242101 A1 describes a method of location determination in which radio resources are assigned to a group of cells for measurements on a device-unique reference signal. GB 2536487 A describes the use of hyperbolic frequency modulated chirps of a known bandwidth whose phase varies with time as a logarithmic function for range determination. An advantage is indicated to be the avoidance of Doppler shift errors. Further systems are described in U.S. Pat. No. 5,526,357 and US 2019/0215712 A1.

Currently available positioning methods that are based on cellular communication systems are limited in the distance accuracy according to the symbol duration that is provided by the cellular system. Therefore, in case a higher accuracy is required, other methods have to be used, which require additional hardware and may be restricted to either outdoor usage only (e.g. GNSS) or indoor usage only. The broad service availability with low cost devices, as typically given for cellular based services, is not possible with current high precision positioning systems. On the other hand, the currently available cellular based positioning solutions cannot deliver a high distance accuracy.

The present invention provides a method of assigning radio resources for transmitting and receiving measurement radio signals for determining a position of a cellular device, wherein at least one of a bandwidth, a pulse form, and a duration of the measurement radio signals is selected according to a positioning accuracy requirement of a requesting device.

This invention enables a mobile communication system to configure radio resources and physical signal shapes (i.e. to select a matching bandwidth, time slots and impulse duration) to be used for positioning with measurement signals, which are significantly shorter than the symbol duration used for communication in the mobile communication system. To achieve the most efficient configuration, the mobile communication network considers information of the current positioning needs.

The invention provides a method, to select the bandwidth and duration of measurement signals which are used for positioning fixes according to the positioning requirements of the requesting devices.

Additional aspects are the selection of appropriate resources for transmission and reception of positioning signals and assignment of resources to UE devices.

The invention describes the selection of signal shape, duration or bandwidth of the positioning signals and resources and corresponding configuration of UE devices by a network to use the selected resources for the selected positioning signals.

It is known to adapt the frequency of recurring positioning fixes to the needs of the positioning service for a specific device with regards to expected changes of the position of the device. As an example, UE devices with a high velocity need a more frequent position fix if the service needs a permanent accurate estimation of the UE device's position. Also, it is known to perform several iterations of a position fix, e.g. between a single device and a varying number of base stations and adapt the iterations to the needs of the positioning service. As an example, a UE device with a lower need for position accuracy performs distance measurements with three base stations for a single position fix while another UE device with higher needs performs distance measurements with five base stations.

One aspect of the present invention is a system for position estimation with variable positioning signals in which the shape of the positioning signals is determined based on the service needs and the available system resources. The shape of the positioning impulse may vary in duration and/or bandwidth and/or form.
The duration may be variable in two or more distinct steps, so that the duration of a single positioning impulse is one of two or more values or is a configurable multiple of a base duration,
the bandwidth may as well be variable in two or more distinct steps so that the bandwidth of the positioning impulse is one of two or more values or a configurable multiple of a minimum bandwidth,
the bandwidth may alternatively be tied to the signal duration so that the product of duration and bandwidth is a constant or configurable figure,
the form of the signal shape may be variable in that it may be two or more configurable variants of a similar form, i.e. a chirp impulse with either rising or declining frequency, or it may have alternative forms to be configured, e.g. chirp and raised cosine.
Any combination of the above is possible for a varying positioning impulse shape.

A positioning requestor will request one or more position fixes providing with the request a position accuracy requirement. Alternatively, different service configurations including a required positioning accuracy are pre-defined and only a service identifier is provided. The requestor may be the UE device itself, requesting a position fix at the base station or more likely at a location service (LCS) server. Alternatively, the requestor may be the LCS server, based on a pre-defined service configuration. Or the requestor is an entity of the mobile communication network or an entity outside that network requesting one or more position fixes of a specific UE device or a group of UE devices from the LCS Server. A service provider outside the mobile communication network may for example need the UE device's position and send an appropriate request. After authorization of the service provider, the LCS server may initiate the position fix. An entity of the mobile operator network may in another example need the UE position, e.g. for optimizing radio parameters, and trigger the LCS server to initiate the position fix.

The position accuracy provided in the position request may be an absolute maximum position deviation from the real position in meters or it may be a deviation relative to the distance from a fixed point. The position accuracy may be provided as a real value or as a selection of a single value from a list or as a quality criterion like “rough estimate”, “normal”, “precise” and “high precision” or similar.

The position accuracy may alternatively or in addition include a requested trackability, which is a device speed up to which the position fix should be precise or should be within a given accuracy.

The position accuracy may alternatively be a UE device specific or user specific value stored in the subscription data base (UMD) and applied to all position fixes or all position fixes without an accuracy parameter provided. In this case, the LCS server may, after receiving a request for position fix, request the respective accuracy parameter from the UDM in the mobile communication network

In another alternative, the accuracy may be service specific. In that case, the accuracy parameter is pre-determined and given by the requestor of the position fix, i.e. it is bound to the service provider outside the mobile communication network or to the purpose of the position fix for a network-internal entity. In this case, the accuracy may also be requested by the LCS server from a policy control function of the mobile communication network, the policy control function providing accuracy and other parameters that are service or third party specific.

The introduction of an LCS server as an entity that controls the location fix does not restrict the invention to be performed solely in a base station or another control entity of the mobile communication network. Also, the functionality may be performed by multiple entities, each contributing a part of the functionality to the whole method and functionality, preferable all entities as a part of the mobile communication network.

After the requestor requested a position fix for a specific UE device or a group of UE devices at the LCS server, the LCS server will request the position fix from an entity of the network that performs position fixes, preferably the base station serving the UE device. In the following, examples only use the single device alternative for ease of readability, which does not restrict the idea to be applicable to a group of UE devices. Also, the following description assumes the serving base station being the entity performing the position fixes which does not restrict other entities, e.g. a non-serving base station or a specific function of the radio network, to perform or control the position fix.

The base station receiving the request selects the shape of the positioning impulse used for the position fixes of a single UE device, in dependence of the positioning accuracy provided with the request and based on the available resources in the cell or cells involved.
The base station may determine the impulse duration from the accuracy parameter provided in the positioning request, so that the positioning impulse is short enough to provide precise enough distance estimations for the involved base station(s), i.e. a shorter duration is selected in case a higher accuracy is required for the position fix. A longer duration is selected, if power and spectrum resource efficiency is more important than positioning accuracy.
Further, the base station may determine the impulse shape from a number of available shapes from the required accuracy. I.e. a shape that includes more zero crossings (like the chirp impulse) is selected, if a higher accuracy is required, and a shape without zero crossings is selected, if a lower transceiver complexity is more important than position accuracy. The determination of the shape may also or mainly be based on the UE device's capabilities to support the shape to be used.
In another example, the base station may select the impulse shape based on an estimated link quality between the involved base station(s) and the UE device. For a better link quality, a shape may be selected that demands, at a given duration, less bandwidth but can only be reliably detected if the link is good enough. For lower link quality, a shape may be selected that demands, at a given duration, more bandwidth and that is more reliably detectable.
Alternatively, the shape is selected based on an estimated interference caused by the selected shape, and an acceptable interference level, e.g. in a cell of the base station or in a neighbour cell.
The base station may for example select the impulse shape based on the distance between the UE device and the base station determined in a previous position fix or the timing advance value or based on a radio link estimation determined during communication between the UE device and the base station or based on a current interference level.
Alternatively, the impulse shape is fixed, either in the whole system or for the UE device, e.g. because the shape is device type specific. In the latter case the determining the shape is basically a look-up from a subscription data base or in UE device capability information stored in the network or provided by the UE device to the base station, the network or a data base.
Based on the duration and the shape, the bandwidth of the impulse can be determined by the base station.
In a different approach, the base station first determines an applicable bandwidth, e.g. from the resources currently available in the cell, and then determines the form of the impulse. From the determined parameters, the impulse duration can be derived.
In another alternative, the mobile communication network only has one impulse shape for position fixes and determines the duration and bandwidth collectively from accuracy demands and available radio resources.
In the preferred alternative, every UE device is capable of only using one impulse shape for positioning with a variable duration and it provides the respective capability information to the base station. For position fixes, the base station then determines the duration of the positioning impulse from required accuracy and optionally a current link quality and it determines the available bandwidth from the available resources. It then calculates according to a pre-determined trade-off function the signal duration and bandwidth for position fixes. The trade-off function may be provided by a policy control server of the mobile communication network.

After determination of the positioning impulse shape, the base station will determine radio resources for use for position fixes for the UE device. It is a further aspect of this invention that radio resources are allocated to position fixes most efficiently. Due to the specific nature of the position techniques used in this invention, the positioning impulses are very short in time in comparison to the radio resources used for communication. Therefore, contiguous radio resources of a cell are allocated to multiple position fixes of the same and/or different UE devices, so that the radio resources collectively fill one or more resource blocks as defined in the time-frequency-grid of resources used for mobile communication.

The 5G mobile communication system defines bandwidth parts (BWP). A BWP is a block of resources, contiguous in time and frequency, which may be configured to UE devices for usage for mobile communication. The bandwidth of a BWP is typically smaller than the system bandwidth provided by the cell. This will ease the power demand of the UEs, in cases where the full system bandwidth is not required. Multiple BWPs with different configuration for the bandwidth, duration and frequency may be configured to a single UE device by the base station so that the base station can later quickly configure the UE device to use or not use each of the configure BWPs. Control and data transmission and reception is then performed in the BWP, so that a UE device configured to use a BWP does not need to receive or transmit outside that BWP. This is in contrast to LTE, where a UE configured to receive data in a cell needs to receive control information on the full cell bandwidth. Without losing generality, this invention uses the concept of bandwidth parts (BWP) to describe the inventive resource allocation for position fixes.

A common radio resource assignment scheme (e.g. as applied in LTE) used for channels shared between multiple users has two steps. The first step is allocation of and configuring a UE device with resources that may potentially be used by the UE device. The second step is a dynamic assignment of resources actually used by the UE. Thus, in legacy cellular communication systems, radio resources configured to UE devices in UL and DL require control information to be exchanged for dynamic assignment. The control information is typically sent on radio resources bound to the resources used for data transmission, i.e. they are timely preceding the data portion, or they are sent on frequency bands adjacent to those used for data transmission. Thus, the typical allocation of resources for legacy communication systems allocates a block of resources in the time-frequency-grid, e.g. a BWP, which block includes resources for control information and data. Especially for a shared channel, DL control information is transmitted by the base station to dynamically assign UL and DL resources on the shared channel. This results in a UE device which is connected to the cellular network (i.e. in RRC-CONNECTED mode) to permanently receive the shared channel control information and look for resource assignment in UL and/or DL so that the shared channel can be used for related UL transmission or DL reception.

A base station allocating radio resources for position fixes will ensure the resources are used exclusively by a single transmitter (interrogator or transponder) for transmission of positioning impulses and the resources are free from any mobile communication. Therefore, a BWP that is used according to this invention is not used for mobile communication but only for consecutive position fixes of one or more UE devices. We call this a positioning BWP (PBWP).

Thus, resources for dynamic control of this PBWP are needed in addition for dynamically assigning measurement slots within the PBWP to UE devices. These control resources cannot be part of the PBWP, as the PBWP is free of mobile communication and it is of extremely short duration and high bandwidth. Accordingly, the configuration of a PBWP to corresponding UE devices for positioning impulse transmission has to include another PBWP or similar resource assignment for control data transmission, the control data being for dynamic assignment of measurements slots.

The PBWP uses a new time-frequency-grid, as the impulse duration is much shorter and more impulses, i.e. more position fixes, fit into even the smallest BWP configurable in the legacy 5G system. The associated control data sent on the separate but associated control resources therefore use a resource assignment mechanism for the new time-frequency-grid.

It is therefore an approach of the invention to allocate a PBWP for positioning fixes and allocate a control block of resources for control data transmission. As the nature of the positioning impulses is of short duration and high bandwidth, the control data block cannot be adjacent and aligned in time or frequency to the positioning PBWP.

That results in the concept of this invention in which a second block of resources is allocated to UE devices for positioning impulse transmission and reception and a first resource block is allocated for control data exchange to the UE devices, the second block being of different bandwidth and different duration of the first resource block and the second block is for transmission of signals much shorter and of much higher bandwidth than the signals transmitted on the first block.

Within the first (control) block, control data may be transmitted by the base station to the UE devices, indicating the measurement slots within the second block that are intended to be used for the UE device's positioning fix. The control data may include an indication of whether the UE device is the interrogator or the transponder, i.e. whether the UE device transmits at the indicated measurement slots a positioning impulse to the base station or it is prepared to receive a measurements impulse from the base station.

This invention also provides resource assignment based on a fixed measurement slot duration, each measurement slot being used for a single or multiple pairs of positioning interrogator and transponder signals (impulses), and the measurement slot being much shorter than the smallest configurable time unit for data transmission, i.e. a sub-frame in the cellular communication system. The length of a measurement slot may be configurable to the UE device, so that the base station can adapt the measurement slot length and thus the resources needed for a single position fix to the specific group of UE devices using the PBWP. The base station may configure different groups of UE devices with different PBWPs that may have different measurement slot lengths. The UE devices within each group may then be determined by the base station to have a common distance to the base station, a similar current quality of the link to the base station or a common accuracy demand or a similar common parameter.

Within the control data UE devices and respective radio resources in the positioning resources should be addressed. In legacy cellular communication systems such as LTE or 5G, a subframe consist of a number of symbols, e.g. 14 symbols, and a symbol has fixed or configurable duration. In LTE for example, the symbol length is about 71 μs (for normal cyclic prefix), in 5G it is variable with the smallest duration being about 4.5 μs. A subframe, i.e. of 1 ms duration, is the smallest addressable resource unit that can be assigned to a UE device.

The positioning measurement slots of this invention are assigned for exchange of one or multiple positioning impulses, each having a duration in the magnitude of 50 to 100 ns. A measurement slot is dedicated to at least one UL and one DL impulse; thus, the minimum measurement slot duration is about 200 ns and with some guard interval for timing uncertainty it can be estimated to about 1 μs which would result in 1000 measurement slots per subframe. Even if the measurement slot duration is determined by the base station to include the time of flight for the impulses of 7 μs (assuming 2 km maximum cell radius), there would be 120 measurement slots per subframe. Thus, an addressing mechanism for measurement slots is needed that is efficient enough to ensure a minimum of communication resources is used for the control data block.

In a first aspect of this invention the frequency and bandwidth used for positioning impulses for a specific UE device is constant throughout a PBWP and it is a configured value, so that there is no need in the dynamic assignment to address the frequency, band or bandwidth a UE device is meant to use for positioning impulses.

A second aspect is to have a UE device within one PBWP to have assigned zero, one or more blocks of one or more consecutive measurement slots in a single PBWP and in case multiple such blocks are assigned, the number of measurements slots per block is identical for all blocks. That means a UE device being assigned a block of three consecutive measurements slots in a PBWP may be assigned another block of three measurement slots but not any block with a different number of measurement slot. As each block is of identical length then the start of a following block is the only value that has to be signalled for all but the first block.

A third aspect is to address UE devices in the control data with an identity, e.g. their Radio Network Temporary Identity (RNTI) allocated and provided by the base station to the UE device before or within the configuration of the PBWPs. As the addressing of UE device only needs to be unique within the UE devices of a cell that are configured to use the same control block for positioning resources, an alternative addressing mechanism may use a shorter identity that supports just sufficient UE device identifications to support the mechanism and thus save signalling bits compared to usage of the RNTI.

A fourth aspect is to introduce an addressing scheme for each PBWP used in a cell. In most legacy cellular communication systems, the control data is part of the same resource block as the resources used for data transmission and reception, therefore control data is implicitly addressed to the data resources. There are other cellular communication systems in which control resources address other resources that are used for data transmission. In this invention, however, the control data block is separated from the positioning resources, i.e. the PBWPs used for positioning, and the control data addresses UE device individual positioning resources, which is yet unknown. Hence, an addressing of PBWPs is proposed that allocates during configuration of a PBWP to UE devices an identification (BWP-ID) to the PBWP that is then used for distinguishing the BWP for positioning impulses from other BWPs for positioning impulses. This mechanism is obviously only needed, if multiple PBWPs are addressed within one control block. Otherwise, a one-to-one relation between control block and PBWP would obsolete this BWP-addressing scheme.

According to the aspects above, the control data assigns to UE devices positioning resources by indicating for each respective UE-ID the one or more PBWP to be used and within the BPW the measurements slot number of the measurement slot where the usage should start and a number of consecutive measurement slot to define the length of the resource block. In case another resource block is assigned within the same PBWP, the start of the first measurement slot of further resource blocks is provided, e.g. in units of measurement slots.

Preferred embodiments of the invention will now be described, by way of example only, with reference to the accompanying drawings in which:

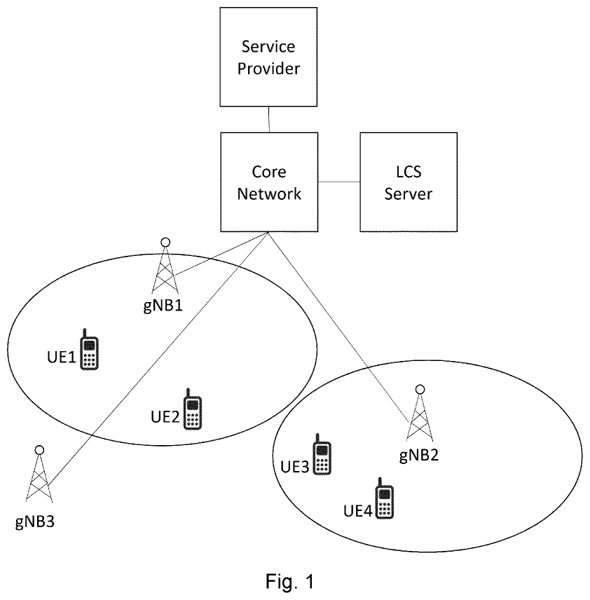

FIG. 1 shows a schematic representation of a cellular network;

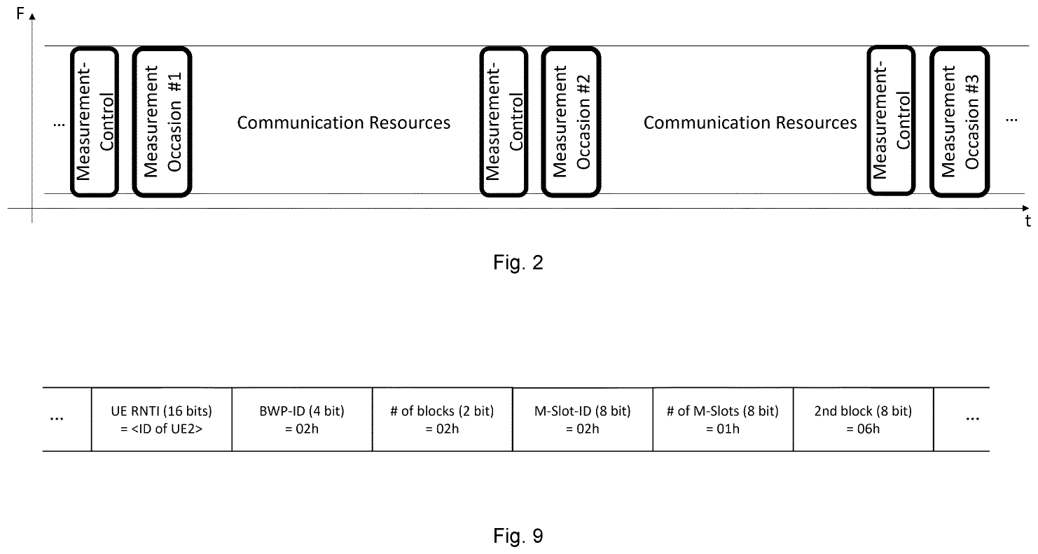

FIG. 2 illustrates a time frequency radio resources grid including position measurement occasions;

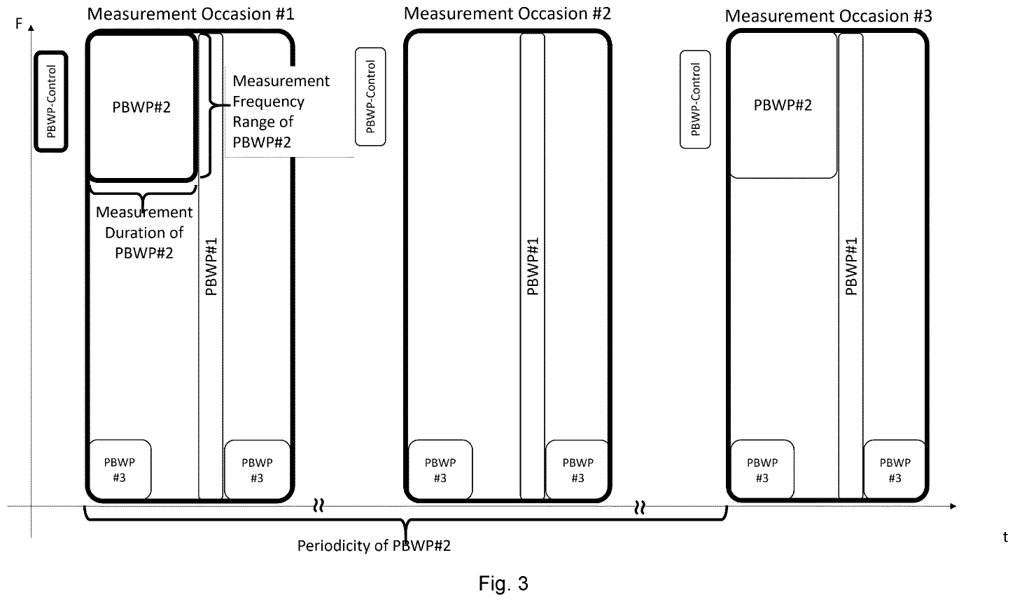

FIG. 3 shows the grid of FIG. 2 in more detail;

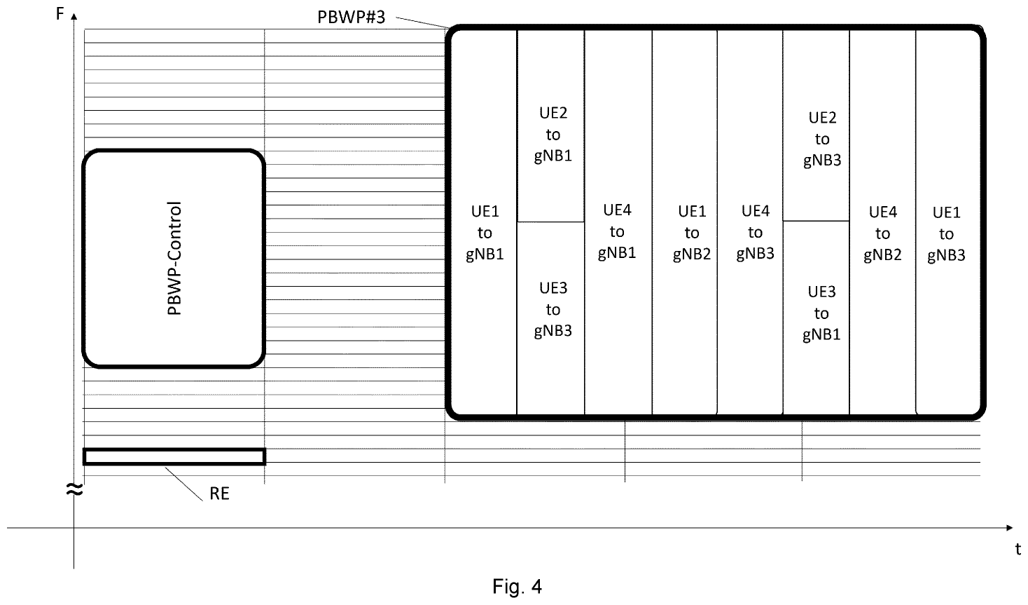

FIG. 4 shows measurement occasions in a time frequency grid at a resource element level;

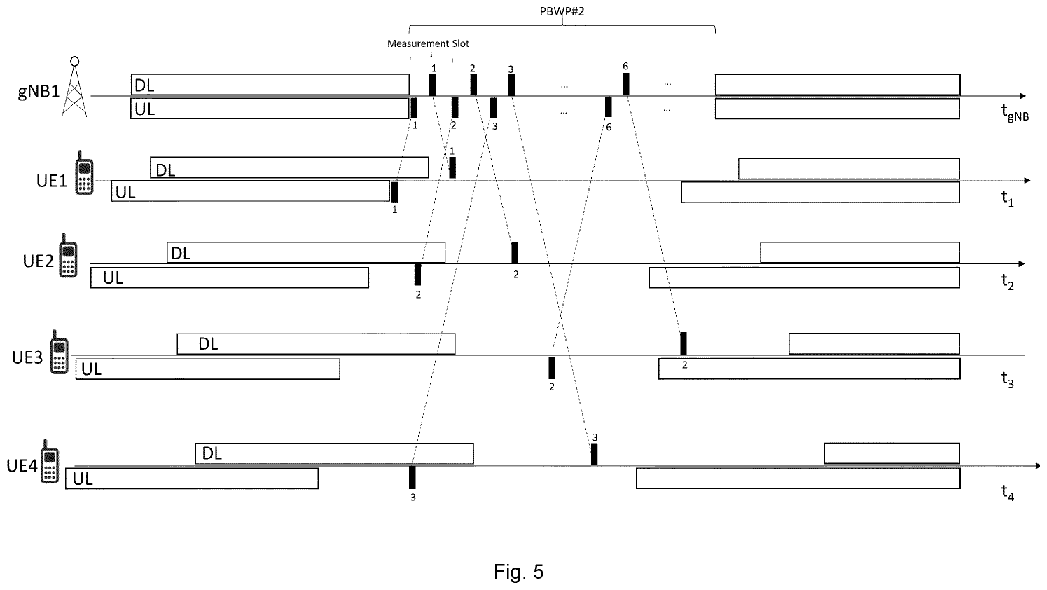

FIG. 5 illustrates a transmission and reception of measurement radio signals between UEs and a base station;

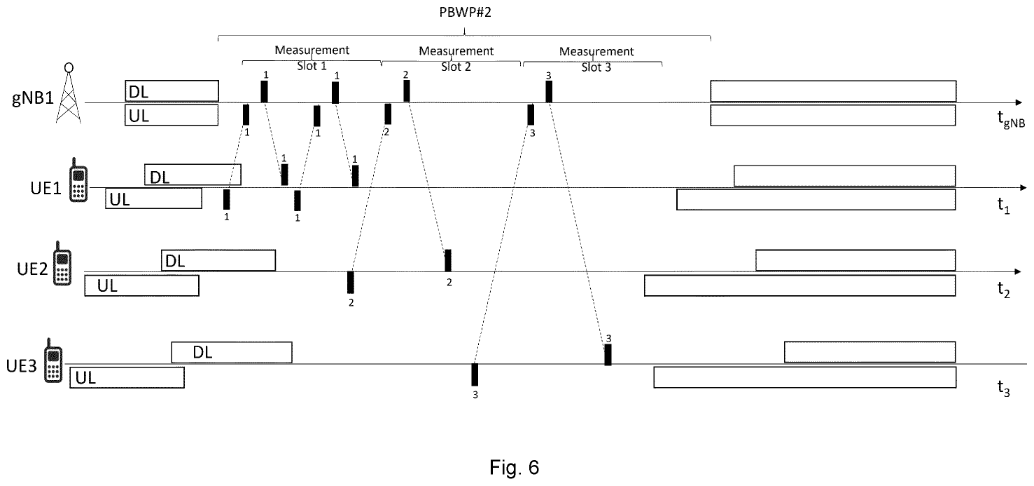

FIG. 6 illustrates the assignment of measurement slots to UEs;

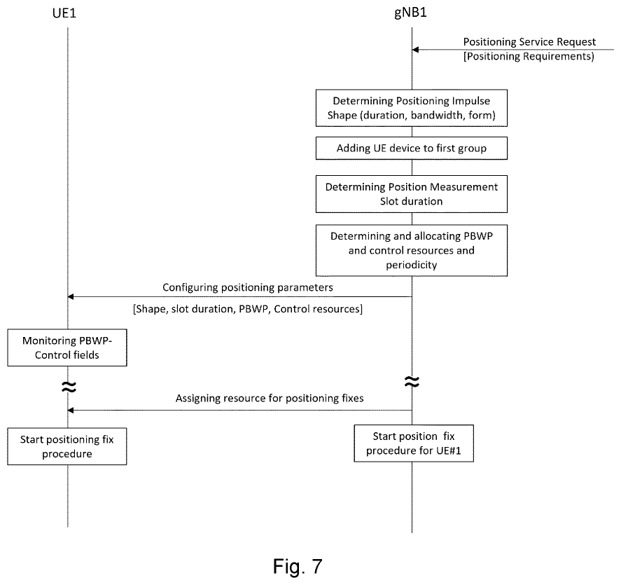

FIG. 7 is an event sequence chart showing an implementation of the invention;

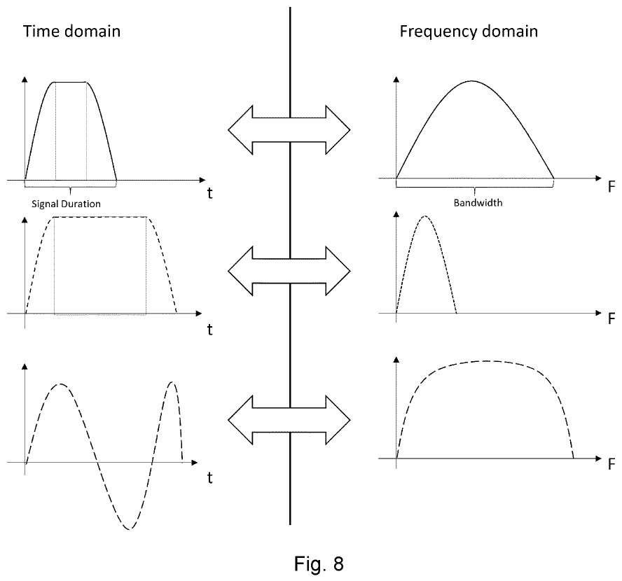

FIG. 8 illustrates a relationship between signals in the time and frequency domain;

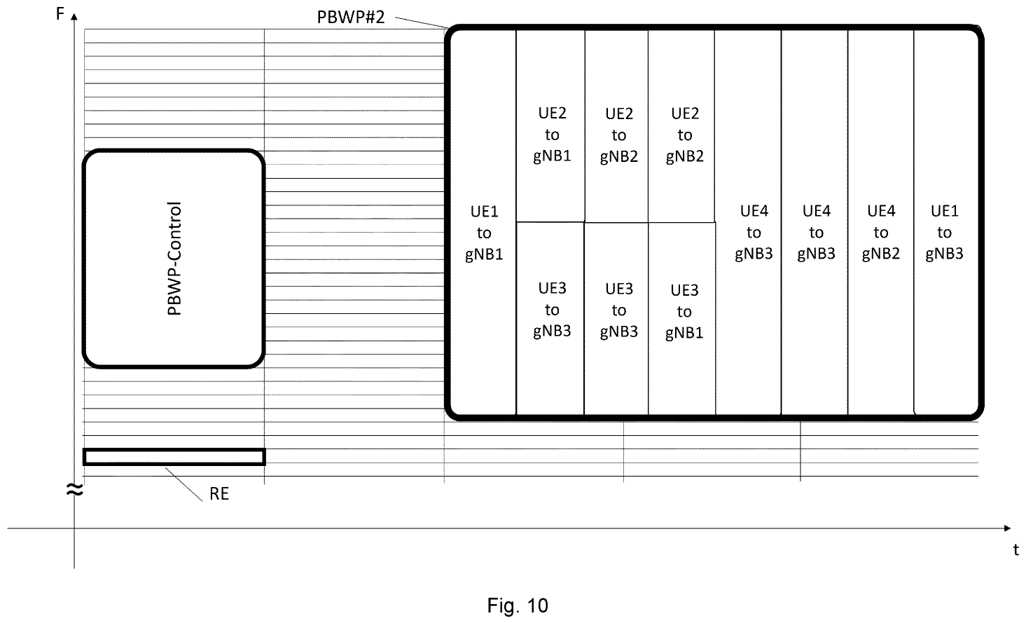

FIG. 9 shows an example of control data for controlling UE2 of FIG. 4;

FIG. 10 shows a further example of resource assignment; and

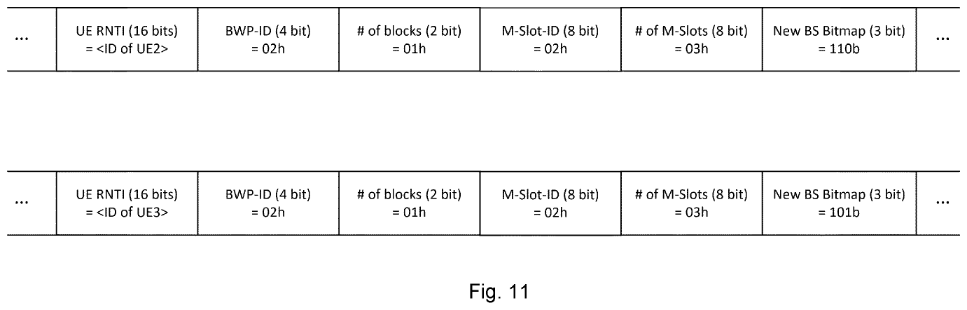

FIG. 11 shows resource assignment information elements for the resource assignment for UE2 and UE3 shown in FIG. 10.

FIG. 1 shows a simplified mobile communication network comprising four UEs devices (UE1, UE2, UE3 and UE4), three base stations (gNB1, gNB2 and gNB3), a core network, a location server (LCS Server) and a third party service provider (Service Provider) enabled for the inventive positioning procedure. UE1 and UE2 may be served by gNB1 indicated by an ellipsis representing the cell spanned by gNB1 while UE3 and UE4 may be served by gNB2. The LCS server is connected to the core network or it may be a part of the core network and exposed for illustration purposes only. The LCS Server is reachable from the UE device via a radio access network, e.g. one of the shown base stations or any other wireless connection, and the core network. The LCS Server is as well reachable by the service provider either directly (not shown) or indirectly via the core network.

FIG. 2 shows a simplified time-frequency-grid of a cell of the cellular mobile communication system of FIG. 1. For illustration purposes the term “measurement occasion” is introduced which is the collection of resources used for position fixes within a restricted time interval. The figure illustrates the position of three measurement occasions. These are intended for positioning signals and consist of resource for position fixes and potentially other resources. Each measurement occasion is accompanied by control resources for controlling the usage of the resources for position fixes. Between these resources, the normal communication resources of the cellular communication system are located. The measurement control is located time-wise before each measurement occasion. The measurement control field includes the resource assignment (RA), which commands the UE device to start positioning in this measurement occasion and indicates the resources within the measurement occasion to be used by the UE device, i.e. the measurement control field contains control information carried by modulated bits and no positioning signals, so the measurement control resources can also be considered as normal communication resources of the cell, yet dedicated for control of the positioning resource usage. The resources for the actual measurements can be located e.g. at the positions of the guard interval within the special subframe of the TDD-mode of LTE or NR (5G).

FIG. 3 shows more details of the three measurement occasions of FIG. 2. Each occasion is divided in multiple positioning bandwidth parts (PBWPs). Each PBWP is defined by a frequency range (bandwidth), a duration and a period, shown for PBWP #2 in FIG. 3. The different configurations enable different positioning properties, e.g. different positioning accuracy and trackability of moving devices. In this example, PBWP #1 enables the highest accuracy, as the bandwidth is the broadest allowing the shortest positioning impulses compared to the other PBWPs. PBWP #3 has the shortest positioning periodicity and enables therefore the best permanent trackability of fast moving UEs. As also depicted in FIG. 3, a measurement occasion does not necessarily bear resources for all PBWPs, each PBWP has its own periodicity and may or may not appear in an occasion. In our example, a measurement occasion is the set of resources collectively controlled by a block of control resources (PBWP-Control).

FIG. 4 shows even more details of PBWP #2 which is embedded in the mobile communication time-frequency-grid for which a single resource element (RE) is shown example wise at the bottom left. PBWP #2 is divided in measurement slots for multiple UE devices (UE1 to UE4) for measurements with respective base stations (gNB1 to gNB3). Each measurement slot in this example bears resources for a single pair of interrogator and transponder signals sent between one UE device and one base station. In another example multiple pairs for a single UE are included in one measurement slot. The measurement slots within the PBWP are typically much shorter in time compared to the symbol duration used for communication resources, i.e. the duration of the resource element (RE) as shown in FIG. 4. The duration of the PBWP-control field is equal to or a multiple of a resource element duration as it carries modulated bits like the communication resources. All resource parts that are not reserved for positioning purposes may be used for communication purposes and are using the respective resource grid, i.e. the symbol duration and the subcarrier spacing according to the resource element size.

As depicted in FIG. 4, the PBWP can be divided in time and frequency direction between different UE devices and between positioning fix iterations of a single UE device, to different or the same base stations. For different accuracy needs, different positioning impulse shapes may be used, e.g. UE2 and UE3 use half of the bandwidth of the PBWP while UE1 and UE4 use the full bandwidth. According to this invention the allocation of different amount of resources to different UE devices is a result of different positioning accuracy requirements so that UE devices UE1 and UE4 use a shorter and more precise positioning shape while UE devices UE2 and UE3 use longer impulse shape which results in half the bandwidth needs. The impulse shape and impulse bandwidth may in one example be determined by the base station before a UE device is configured and the shape and bandwidth are then configured to the UE device. Then, only the timewise occurrence of the positioning resources needs to be dynamically assigned.

In the current embodiment, all measurement slots are of equal duration while in other embodiments it may be foreseen that the measurement slot duration is variable. It may for example depend on the duration of the impulse shape and in some embodiments the time of flight of the signal, i.e. the estimated distance between UE and base station. As this distance can hardly be estimated before the resource allocation, the preferred embodiment is a fixed length measurement slot as depicted in FIG. 4.

A measurement slot may be long enough in time to fit multiple position fixes, but because of the unknown or not precisely known time of flight of positioning impulses, the number of position fixes fitting into an allocated measurement slot or into multiple consecutive slots assigned to a single UE device may not be known beforehand. One embodiment could foresee that a UE device having the role of an interrogator, i.e. initiating a position fix, may transmit a first interrogator signal and receive the corresponding transponder signal within the allocated resources and measure the time between this transmission and the related reception. The UE device may then determine whether the time elapsed between transmission and reception fits another time into the allocated resources, i.e. into one or more consecutively assigned measurements slots, and if so, perform another positioning fix with the same base station. This procedure may be repeated until no position fix can be performed within the remaining part of the assigned resources. In a positioning system similar to that described in DE 102015013453 B3 this process allows several iterations of position fixes and thus a very accurate position estimation within one assigned block of measurement slots.

In case the UE device has the role of the transponder it may be foreseen that the UE device is prepared to receive interrogator signals and respond with respective transponder signals during the complete duration of the assigned resources so that a base station can decide how many repeated position fixes to perform with the UE device within the assigned resources.

The PBWP-control resource block as shown in FIG. 4 must use resources that lay time-wise before the PBWP. The control block may comprise control information for multiple PBWPs that are not shown in FIG. 4, e.g. for PBWP #1 and PBWP #3 of FIG. 3.

As one example, a part of control data for UE2 according to FIG. 4 is shown in FIG. 9. The control data is assigned to UE2 in a first information element identifying the UE device with its RNTI. In a following information element that may for example be four bits long, the PBWP is identified which is to be used by the UE device for position fixes and which is addressed for the following assignment. The next information element may indicate the number of measurement blocks, each block comprising one or more immediately consecutive measurement slots assigned to UE2; in this example two blocks according to FIG. 4 are assigned to UE2. For each of these blocks a start slot number is indicated in following information elements, in the example these are measurement slot number 2 and 6 and for the first block, a number of consecutively assigned measurements slots, in the example 1, is indicated. Similar information may be signalled by the base station for further PBWPs used by UE2 and for further UE devices for position fixes.

FIG. 10 depicts details of the resource assignment of a different system in a different example. In this example UE2 is assigned three consecutive measurement slots, the first for a position fix with base station gNB1, and the second and third for position fixes with gNB2, respectively. Also, FIG. 10 shows the resource assignment to UE3 which is assigned two consecutive measurement slots for position fixes with base station gNB3 and one following measurement slot for position fixes with base station gNB1. In contrast to the example shown in FIG. 4 and FIG. 9, in this example the assigning base station informs the UE about whether a measurement slot is for a different or the same base station as the preceding position fix. FIG. 11 shows the resource assignment information elements in this example for UE2 and UE3. These are very similar to those of the last example shown in FIG. 9. FIG. 10 differs in depicting the assignment data for assigning one block of three measurement slots to UE2 (upper part) and UE3 (lower part), respectively. The new aspect introduced by this new example is depicted in a new information element in the assignment data, here called New BS bitmap. The bitmap indicates for each of the assigned measurement slots, whether it is for position fixes with a new base station or it is for continued measurement fixes with the preceding base station. As a result, the respective UE device can, as described for example in DE 102015013453 B3, reset their registers that are maintained over position fixes with the same base station and which need resetting whenever the positioning is started with a new base station.

The information elements of FIGS. 9 and 11 are only examples to illustrate the proposed control mechanism for position resources. Various other forms of control signalling can be used to implement the various aspects of the current invention.

FIG. 5 depicts the transmission and reception of positioning impulses between UE devices UE1 to UE4 and one base station (gNB1) assuming a resource assignment according to FIG. 4. The figure focuses on resource usage with regards to gNB1 while other resources used for position fixes with other base stations are not shown. As usual in cellular mobile communication systems, the resource grid and respective allocation and assignment of resources to different UE devices is described at the location and with the timing of the base station. The base station assigns resources timewise according to the transmission and reception point in time at the base station.

UE devices are configured with a timing advance (TA) value representing an estimation of the time of flight of signals between the UE device and the base station. UE devices transmit signals at a time advanced by TA compared to the received DL timing to ensure the signals are received in-sync at the base station. UE devices expect signals sent by the base station to arrive at the UE by TA later. As depicted in FIG. 5, on the time axes of gNB1 three blocks of resources are present, a first communication block for mobile communication shaded in grey, a measurement occasion for PBWP #2, and a second communication block for mobile communication again shaded in grey. Within PBWP #2, measurement slots are shown, namely slot 1, 2, 3 and 6 whereas slots 4, 5 and further slots after 6 are indicated by three dots “ . . . ”.

According to FIG. 4 a first measurement slot of PBWP #2 is assigned to a positioning fix of UE1 with the UE being the interrogator, thus transmitting a positioning impulse (1) in UL. As depicted in FIG. 5, the impulse is received by gNB1 and a transponder signal is transmitted back in DL. The next measurement slot (2) is assigned to UE2 and UE3, respectively on different frequency ranges and intended for different gNBs. FIG. 5 only depicts the positioning impulses for gNB1. Measurement slot (3) is assigned to UE5 for a position fix with gNB1 as shown in FIGS. 4 and 5. Measurement slots (4) and (5) are assigned to UE1 and UE4 for position fixes with gNB2 and gNB3, respectively, so that gNB1 does not receive or transmit any signals in these resources. The next transmission towards gNB1 is according to FIG. 4 in measurement slot #6 by UE3 as shown in FIG. 5.

FIG. 6 shows another example of resource assignment with a longer measurement slot to illustrate the embodiment of a UE device, in this case UE1, performing multiple position fixes within one measurement slot. The UE device can perform the additional position fix after determining that a second interrogator signal sent from UE1 will be received in the gNB within the assigned measurement slot. The determining may take into account measurement slot duration, the time elapsed between transmission of the interrogator signal and reception of the transponder signal in the first position fix, and/or the TA configured to the UE device. The same determination leads to UE devices 2 and 3 in the example of FIG. 6 to only perform a single position fix within their assigned measurement slot as obvious from the figure.

One specific embodiment of the current invention is the allocation and configuration of resources for position fixes, e.g. in a PBWP, so, that the resources fit into the guard interval of the so called special subframe of a time duplex communication system, e.g. LTE TDD or NR TDD. This guard interval has a length of 1 to 10 symbols which mark the transformation between the DL usage of the resources and the UL usage. Within this guard interval, neither UE devices nor the base station transmits signals except for the UE devices transmitting UL signals of the subsequent subframe advanced by their timing advance within the special subframe. The guard interval is generally free of signals at the gNB and can be used by the current invention to carry a PBWP for position signals. There is no need to instruct other UEs to free these resources. Only the involved UEs may be instructed to shorten the DL reception immediately before a positioning impulse is sent. E.g. UE1 in FIG. 6 may shorten DL reception and the gNB will shorten DL transmission for this UE to avoid the shown overlap between the DL and the positioning impulse. For UE2 and UE3 this shortening is not required, as can be seen in FIG. 6. The shortening of DL reception can easily be taken into account in the scheduling of DL communication resources by the base station, so that this aspect does not have any drawback for the system.

In order to enable a reliable reception of the PBWP-control field, the PBWP-control field is scheduled so that an interval of time appears after the PBWP-control field before the related PBWP, as depicted in FIG. 4. This is configured to be about the maximum TA value of the involved UEs. The proposed scheduling will prevent an overlap at the UEs of the PBWP-control field and the transmission of an interrogator impulse.

In case the special subframe is used as measurement occasion, the control information having the assignment data is sent before the special subframe, preferably in the last subframe before the special subframe. The invention would then claim a base station to configure both a special subframe with silence for changing from DL to UL transmission and a PBWP at the same or at least an overlapping time interval for exchange (UL and DL) of position signals.

FIG. 8 shows the relation of signal duration and bandwidth for three different impulse shapes. At the top of FIG. 8 on the left an arbitrary impulse with a defined signal duration is shown in the time domain. This pulse corresponds to the shape given on the top right of the figure in the frequency domain having a resulting bandwidth. The example impulses and shapes are not exact, they are just selected to illustrate the physical principle that is the base for the current invention. In the mid left of the figure a similar impulse, yet with a longer duration in the time domain, is shown and evidently this pulse corresponds to a shape in the frequency domain with a smaller bandwidth as shown in the mid right of FIG. 8. A third example is a chirp impulse in the time domain as shown in the bottom left. The signal duration may be longer than the first example pulse, yet the bandwidth of that impulse is still larger than that of the first and second example impulses. The figure thus illustrates, that the bandwidth of an impulse is inversely proportional to the signal duration and also depends on the impulse shape.

A method for positioning resource allocation and assignment proposed in this invention is shown in FIG. 7. It comprises the following steps:
the base station receives a positioning request comprising a requested positioning parameter indicating a requested accuracy of the positioning fix,
the base station determining a position impulse shape (duration, bandwidth, form) for the UE device's positioning fixes,
the base station optionally grouping UE devices with at least one common parameter regarding the impulse shape or regarding their distance to the base station into a first group of UE devices,
the base station determining a measurement slot duration from the requested accuracy and from further conditions (e.g. signal quality and rough base station to UE distance) and optionally a measurement resource frequency from the requested trackability,
the base station allocating first resources for positioning fixes and second resources for control of the first resources, including a resource periodicity for recurring resources, to UE devices of the first group,
the base station configuring the UE devices accordingly,
the base station scheduling positioning fixes in the allocated first resources and indicating these by transmitting control information on the second resources to the respective UE devices, thereby assigning scheduled position fixes one or more measurement slots of the determined measurement slot duration,
the base station (as interrogator) transmitting position measurement impulses to a UE device of the first group and thereafter being prepared to receive a transponder signal from the UE device; or the base station acting in the opposite direction as transponder.
the UE device receiving a configuration from a base station, the configuration comprising
   first resources for positioning fixes,
   second resources for reception of control information regarding the first resources,
   a positioning impulse shape (duration, bandwidth and/or shape),
   a measurement slot duration (if not fixed system wide), and (optionally) an indication of a role as interrogator or transponder the UE device shall take.
the UE device receiving on the second resources an indication of measurement slots assigned to the UE device, and
the UE (as interrogator) transmitting position measurement impulses according to the configured impulse shape to the base station and thereafter being prepared to receive a transponder signal according to the configuration from the base station; or the UE device acting in the opposite direction as transponder.

While the above method configures and assigns radio resources to UE devices for position fixes with a single base station, e.g. with the base station that allocates, configures and assigns the radio resources, this will result in an estimation of the distance between a UE device and the base station. For an estimation of the geographical position, however, multiple such distance measurements with different reference points are necessary. The reference points can be other base stations, e.g. pico base stations or macro base stations, or any other reference points that are able to perform the position fix using interrogator and transponder signals.

The UE device, configured with resources for position fixes and individually assigned such resources for actual performance of a position fix, does not need to distinguish between different base stations. That is, resources assigned to an individual UE device for position fixes can be used to perform position fixes to multiple different base stations. Depending on the method applied for the position fix, the UE device may not even need to know that positioning is done with different base stations, e.g. when using the method described in DE 102015013453 B3 and the UE device is the transponder. Alternatively, e.g. when the same method is applied and the UE device is the interrogator, the UE device may simply need to know for consecutive position resource assignments, whether they are for continued position fixes with the same base station or they are for a first position fix with a new base station. It is thus an aspect of this invention to include in the resource assignments sent by the base station to the UE device a “new base station” flag indicating to the UE device that the respective position fix is not related to the base station used previously but to a new base station. In this case the UE will reset the previously derived timings relating to the previous base station.

The base stations involved in position fixes, however, need to align their timing and the resource configuration for position fixes. The resource configuration needs to be done by a single base station, i.e. the serving base station, here called primary base station, because only that base station can communicate with the UE device and configure it. Other base stations involved, here called secondary base stations, need to perform their position fixes with the UE device at exactly the timing assigned to the UE device by the primary base station. It is thus another aspect of this invention to have PBWPs allocated by a primary base station to a UE device communicated by the primary base station to a secondary base station to firstly silence the secondary base station with regard to their cellular data communication and secondly provide measurement slot timing to the secondary base stations for position fixes between the secondary base stations and the UE device.

1. A method of assigning radio resources for transmitting and receiving measurement radio signals for determining a position of a cellular device, wherein at least one of a bandwidth, a pulse form, and a duration of the measurement radio signals is selected according to a positioning accuracy requirement of a requesting device.

2. The method according to claim 1, wherein the duration of the measurement radio signal is selected dependent on an accuracy parameter provided in a positioning request message.

3. The method according to claim 1, wherein the pulse form is selected dependent on an estimated link quality between a base station and a user equipment device.

4. The method according to claim 1, wherein the pulse form is selected dependent on a known measurement of distance between a base station and a user equipment device.

5. The method according to claim 1, wherein the pulse form is selected from one of a plurality of predetermined pulse shapes.

6. The method according to claim 1, wherein a measurement time slot is provided for transmission of the measurement radio signals, each slot being used for the transmission of one or more measurement radio signals.

7. The method according to claim 6, wherein the number of measurement radio signals transmitted in the measurement time slot is dependent on the duration of the one or more measurement radio signals to be transmitted.

8. The method according to claim 6, wherein for providing the measurement time slot information indicating whether the measurement radio signals are to be transmitted to the same receiving device as previously transmitted measurement radio signals is taken into account.

9. The method according to claim 6, wherein the measurement time slot is located time-wise within a special subframe of a cell of a time division duplex cellular communication system, the special subframe being a time interval of absence of cellular radio signals for switching between uplink and downlink signal exchange between devices of the cell.

10. The method according to claim 1, wherein a user equipment device is assigned a predetermined number of resource blocks within one or more measurement time slots in a single positioning bandwidth part defined according to a 3GPP 5G radio standard.

11. The method according to claim 1, wherein for performing the transmission of measurement radio signals, a user equipment device is addressed using an address having fewer bits than a radio network temporary identity.

12. The method according to claim 1, wherein an addressing scheme is provided for identifying a positioning bandwidth part in the available radio resources of a cell.

13. The method according to claim 2, wherein the pulse form is selected dependent on an estimated link quality between a base station and a user equipment device.

14. The method according to claim 2, wherein the pulse form is selected dependent on a known measurement of distance between a base station and a user equipment device.

15. The method according to claim 3, wherein the pulse form is selected from one of a plurality of predetermined pulse shapes.

16. The method according to claim 2, wherein a measurement time slot is provided for transmission of the measurement radio signals, each slot being used for the transmission of one or more measurement radio signals.

17. The method according to claim 16, wherein the number of measurement radio signals transmitted in the measurement time slot is dependent on the duration of the one or more measurement radio signals to be transmitted.

18. The method according to claim 2, wherein a user equipment device is assigned a predetermined number of resource blocks within one or more measurement time slots in a single positioning bandwidth part defined according to a 3GPP 5G radio standard.

19. The method according to claim 2, wherein for performing the transmission of measurement radio signals, a user equipment device is addressed using an address having fewer bits than a radio network temporary identity.

20. The method according to claim 2, wherein an addressing scheme is provided for identifying a positioning bandwidth part in the available radio resources of a cell.
